(19) United States
(12) Patent Application Publication
(10) Pub. No.: US 2019/0226450 A1
(43) Pub. Date: Jul. 25, 2019

(54) ELECTROMECHANICAL DRIVE SYSTEM

(71) Applicant: Moog Unna GmbH, Unna (DE)

(72) Inventors: Tobias Theopold, Dortmund (DE); Matthias Pauli, Bad Wünnenberg (DE); Denis O'Sullivan, County Cork (IE); Robert O'Sullivan, County Cork (IE)

(21) Appl. No.: 15/527,300

(22) PCT Filed: Nov. 18, 2015
(86) PCT No.: PCT/EP2015/077026

§ 371 Date: May 16, 2017

(30) Foreign Application Priority Data
Nov. 18, 2014 (EP) 14193755.7

(51) Int. Cl. F03D 7/02; G05B 19/048

(52) U.S. Cl. CPC F03D 7/0224; G05B 19/048; F03D 7/024; F03D 7/0276; F05B 2270/327; F05B 2260/76; F05B 2270/602; F05B 2270/107; G05B 2219/2619

(57) ABSTRACT

The present invention provides an electromechanical drive system (1) with at least one electromechanical drive unit (2) to actuate a movable component (3). The electromechanical drive unit (2) comprises a drive unit interface 20 for receiving drive unit control signals (DA), an electromechanical motor (21) controlled by actuation signals (AS) to actuate the component (3), a safety module (4) and a position sensor (5) connected to the safety module via a first data connection (51). The position sensor is adapted to monitor (S1) component (3) and/or motor (21) position and/or speed of the actuated component (3) and/or motor (21); where the safety module (4) is connected to the drive unit interface (20) for receiving the drive unit control signal (DA), and where the safety module is connected to the motor control unit (22) via a third data connection (41) to transmit actuation signals (AS) like actuation speed and desired component position to the motor control unit (22) for actuating (A) the component (3). The safety module (4) comprises as a safety function (SF) at least the actuation (A) of the component (3) in a resting or neutral position (FP), whereby the safety module (4) is configured to decide on basis of the sensor data received from the position sensor (5) whether to continue to actuate the component (3) until it has reached its resting or neutral position (FP) or to stop the actuation of the component (3).

### FIELD OF THE INVENTION

The present invention relates to an electromechanical drive system and a method to operate such a drive system as well as a pitch system and a wind turbine each comprising such drive systems.

### BACKGROUND OF THE INVENTION

There are several applications, where components have to be actuated, e.g. moved or rotated. In case of components, where the position and actuation dynamics have a large impact on the device, system or environmental safety, the component is a safety-relevant component and its actuation has to be carried out with high integrity and reliability. Such drive components fulfilling high safety requirements have to be carefully designed and tested to avoid systematic errors and random control errors supported by diagnostic functions. In order to fulfill the safety requirements, commercial available electromechanical drives comprise highly advanced motors and motor control units using components manufactured with cost-intensive high mechanical precision, comprising additional expensive feedback control circuits and expensive and highly reliable control software. The resulting drive components correspondingly have high development and design costs as well as high manufacturing costs.

From EP 2 372 478 A2 a motor controller and a safety module comprising a motor control part configured to perform the power supply control to a motor are known wherein the safety controller supervises a first and a second sensor. The safety module is a function expander additionally connected to the motor controller. The motor driving system is surrounded by a first safety fence with a first door. The first safety fence is surrounded by a second safety fence with a second door. In case the second sensor notifies the safety module that the second door is open, the safety module as a precaution will decelerate the motor. In case the first sensor notifies the safety module that the first door is open, the safety module will stop the motor.

U.S. Pat. No. 7,911,333 B2 describes a method for motion monitoring of a machine, comprising a sensor, wherein a sensor signal is transmitted from the sensor to a controller or drive device, a failsafe controller or drive device comprising three independent monitoring devices to protect the machine operation from hazardous motions. The known drive device has two shut down paths for increasing redundancy in case a failure occurs.

It would be desirable to obtain electromechanical drives providing the same level of safety, which can be manufactured at lower costs.

### SUMMARY OF THE INVENTION

It is the object of the present invention to provide a drive system for actuating safety-relevant components, which fulfils safety requirements for actuating these components with a high level of reliability and integrity, which is simultaneously easily implementable at low costs.

This object is solved by an electromechanical drive system with at least one electromechanical drive unit to actuate a movable component, the electromechanical drive unit comprising a drive unit interface for receiving drive unit control signals, an electromechanical motor controlled by actuation signals to actuate the component, a safety module and a position sensor connected to the safety module via a first data connection, the position sensor being adapted to monitor component and/or motor position and/or speed of the actuated component and/or motor; where the safety module is connected to the drive unit interface for receiving the drive unit control signal, and where the safety module is connected to the motor control unit via a third data connection to transmit actuation signals like actuation speed and desired component position to the motor control unit for actuating the component. The safety module has at least implemented as a safety functions the actuation of the component in a resting or neutral position The safety module is configured to decide on basis of the sensor data received from the position sensor whether to actuate the component until it has reached its resting or neutral position or to stop the actuation of the component.

The electromechanical drive system may be any system to actuate a component, where the actuation is not limited to a certain type of actuation. For example, actuations might be linear movements or rotations in one or more directions, e.g. movements forth and/or back in case of linear movements or rotations to the right and/or left in case of rotations, where the electromechanical drive system according to the present inventions is limited to applications, where reliability and integrity of the actuation of the component is safety-relevant for operating the component and corresponding diagnostic measures are in place. These boundary conditions are fulfilled by the presence of at least the safety module and the position sensor ensuring safe actuation of the component, where the terms “safe” and “safety” denote components suitable to perform and/or control actuations, which have to be performed with a degree of reliability, integrity and diagnostics sufficient to fulfill safety requirements for release of such systems for safety-relevant applications developed in accordance to the IEC 61508 Standard and/or the IEC 13849 Standard. In case of a pitch system for wind turbines comprising the electromechanical drive system, the electromechanical drive system is developed in accordance to the IEC 61400 Standard for wind turbines. In contrast to that the term “conventional” denotes components, such as conventional motor control unit, conventional power unit and conventional measuring unit, which are not adapted to any specific safety standard to provide sufficient reliability, integrity and diagnostics for actuation of a component without support by other additional components.

The electromechanical drive unit according to the present invention fulfills the safety requirements for actuating the movable component although this unit also comprises conventional components due to its interaction with the safe components, here the safety module and the position sensor, in specified way in accordance to the present invention providing overall reliability, integrity and diagnostics (=safety) of the electromechanical drive unit. From here on in this document the position sensor connected to the safety module is termed safety position sensor as it is connected directly to the safety module. Thus it should not be confused with other positions sensors that may exist at other locations but which are not connected directly to the safety module. To achieve a certain safety integrity level it may be required that the safety position sensor also fulfills safety requirements such as those mentioned above.

The electromechanical motor to actuate the component might be any suitable motor. The motor does not have to comply with the safety standards to be fulfilled by the electromechanical drive system. The conventional power unit to power the electromechanical motor might be any power unit suitable to power the motor providing power requirements to the electromechanical motor. As an example, the conventional power unit may comprise amplifiers, inverters, gate drives and final power outputs to motor and brakes. The power source to power the system might be an internal power source, e.g. a battery, or an external power source, e.g. the grid, connected to the electromechanical drive system via suitable connection. The conventional motor control unit and the conventional power unit might be arranged on single or on a combined PCB.

The conventional motor control unit might be any control unit suitable to control the motor in order to execute the demanded actuations or stops via motor control signals denoting signals to actuate the motor, e.g. to rotate the motor with a specified speed until a certain actuation of the component is executed, to vary this speed, to decelerate the motor and/or to stop the motor (brake the motor). The motor control signals regarding motor speed might be outputted as PWM signals, the motor control signals regarding the brake operations might be outputted as PWM brake control signals. As an example the motor brake might be a holding permanent magnetic brake. Pulse-width modulation (PWM) is a modulation technique that controls the width (in time) of an electrical pulse based on modulator signal information. This modulation is mainly used to allow the control of the power supplied to electrical devices, especially to inertial loads such as motors.

In a conventional motor control unit a motor control interface of the conventional motor control unit is directly connected to the drive unit interface. Thus conventional drive unit drive control signals received via the drive unit interface form the actuation signals, which are directly transferred to the motor control unit as actuation signals or actuation commands, respectively. The safety module in this concept is connected to the drive unit interface practically forming a second data connection and to the conventional motor control unit via a third data connection, e.g. a data bus. Thus the safety module acts as a man-in-the-middle device between the conventional motor control unit and a data source providing demanded input data to execute a component actuation to a certain positions in a certain way in accordance to one or more safety functions. The data source might be an external data source like a central unit, where in response actuation signals like actuation speed and desired component position are transmitted from the safety module to the conventional motor control unit. The safety functions implemented on the safety module ensure safe actuation of the component ensuring reliability, integrity and diagnostics of the actuations. Therefore the safety module monitors position and/or speed of the component via comparing it with the reference signal and the corresponding data determined from the sensor signals received from the safety position sensor (providing safe position and/or speed data). The safety module may pass actuation commands received via the second data connection transparently to the third data connection if none of the safety rules are infringed and the safety position sensor data indicates no malfunction of the motor drive unit or the safety position sensor itself.

Using the sensor data from the safety position sensor the safety module is enabled to perform plausibility checks for deciding whether the information from the safety position sensor, the information from a motor measuring unit or none of these information should be trusted. As a result of this plausibility check the safety module may decide to continue the normal operation, to enter into an emergency situation and to actuate the component until it has reached a resting or neutral position, or even to stop the component, in case the plausibility check suggests it is too risky to try to continue to actuate the component to the resting or neutral position. In case safety rules are infringed or the safety position sensor indicates via an error signal that its own sensor signal cannot be trusted the safety module, depending on the gravity of the malfunction of infringement of the safety rules may decide to modify the control signals received via its data drive unit interface and transmit the modified signals or commands via the third data connection to the motor control unit or generate signals or commands to stop the electromechanical motor immediately. The modification of the motor control signal or motor control commands may even include to increase the speed of the motor.

The term position sensors is a general known term in engineering describing basically sensors for measuring the distance travelled by a supervised component starting from a reference position. How far the component has been displaced from its reference or initial position is sensed by the position sensor either as an absolute value or as an incremental value. As a function of the motion of the supervised component position sensors may measure a linear position or an angular position. It is also well-known that by taking into account the time of a measured displacement the sensor data of any position sensor can be transformed into speed information or acceleration information of the supervised component. As this is a reversible function every speed information or acceleration information can be used to calculate a position when at least one reference point is given. Therefore the term position sensor shall cover all kind of sensors that directly or indirectly (via reference point, speed or acceleration information) give an indication of the position of the actuated component.

The sensor signals comprising position and/or speed data transmitted from the safety position sensor to the safety module may be based on measured component position and/or speed of the actuated component. In an alternative embodiment the data transmitted from the safety position sensor may be based on measured motor position and/or speed of the motor as long as the data measured from the motor provide a sufficient degree of reliability and integrity to fulfill safety requirements. Here the safety position sensor might be attached to the motor shaft, where a direct correlation between shaft position and speed and component position and speed exists. In some applications the actuated component may be connected indirectly to the electromechanical motor, for example by a transmission such as a gear box. The transmissions may either be used to increase the speed of the actuated component or to increase the torque for actuating the component. The sensor signals are further processed by the safety module in order to calculate component position and/or speed from the motor position and/or speed by taking into account the transmission ratio of the transmission.

In an embodiment the safety position sensor is a position encoder, preferably a safe rotary encoder converting rotary position of the component to an analog (e.g., analog quadrature) or digital (e.g., digital quadrature, 32-bit parallel, or USB) electronic signal or linear encoder similarly converting linear position of the component to an electronic signal providing safe absolute position and/or speed and fault status data via a FS-bus interface developed according to the IEC 61508 Standard as the first data connection to the safety module. A FS-bus denotes any safe bus based data communication protocol compliant with IEC 61784-3 or its corresponding additional specification IEC 61784-3-x. In case of a rotary encoder for rotations as the actuations the safety position sensor might be a SIL rated multi-turn encoder. The position and/or speed data provided by the safety position sensor are also denoted as safe position and/or speed data. Some of the position decoders that are approved for a certain safety integrity level supervise their own proper functioning. In case those position sensors detect a mal function or that the data they provide may be faulty, those sensors generate an error signal or an error code, respectively. Although there is no absolute guarantee that a failsafe device that indicates its error free operation is really error free, from a statistical approach the results of a failsafe device, indicating its error free operation can be trusted more, than a sensor that does not provide such information.

The first safety function actuates the component in a resting or neutral position in an emergency situation. This resting or neutral position denotes a position, where the component will not be damaged and the environment around the component will not be endangered by the component or by malfunctions of the component. As an example, the first safety function in case wind turbines denotes a safe feathering run turning the rotor blades out of the wind in order to establish a feathering position for the rotor blades.

For execution of safety functions by the safety module, the safety module comprises one or more processors or computer chips able to execute one or more programmed procedure and/or to control semiconductor components installed on the safety module in order to execute the programmed procedures. The required components of the safety module are connected directly or indirectly via interfaces within the safety module or to the other components of the electromechanical drive unit in order to execute the programmed procedures.

The provided electromechanical drive system for actuating safety-relevant components fulfils safety requirements for actuating these components with a high level of reliability, integrity and diagnostics, which is simultaneously easily implementable at low costs, because the motor and control components such as motor control unit, power unit and measuring unit can be used as conventional components, which are implementable with low manufacturing, testing and release effort lowering the manufacturing and implementing costs of the conventional components. The safety functions are implemented within only two components, the safety module and the safety position sensor reducing the overall costs for a safe electromechanical drive unit. This reduces the development costs for applied component software significantly, since common software for controlling the conventional components can be used. Furthermore the electromechanical drive system according to the present invention provides a safe drive system, where the safety functions are not limited to only stop the corresponding component in the current position, but also being able to drive the component from a current position into a safe position providing a combination of moving and stopping of the component in a safe manner.

In an embodiment the safety functions implemented on the safety module further comprise one or more of the safety functions of the following functions safe-limited-position-control function to ensure the position of the component being within an allowed position range, safe-limited-speed-control function to ensure the speed of the actuated component not exceeding a maximum speed, safe-direction-control function to ensure the component being actuated into the desired direction, safe-torque-off-control function to ensure that the torque applied to the component is zero, safe-brake-control function to ensure the brake of the motor is applied and/or safe-stop-control function to ensure execution of a stopping procedure in accordance to other safety functions and where the safety module is suitably adapted (or designed) to execute the implemented safety functions. The safety functions are implemented as suitable hardware/software modules comprising processors to run the function related software within the safety module. Applying these safety functions the component can be controlled in a safety mode for all possible situations

The safe-limited-position-control function monitors the component position such that the components stay within a defined position range. E.g. in case of rotor blades of a wind turbine as the actuated component the limited position range is between 0° and 90° blade position, where 90° denotes the feathering position and 0° denotes the position, where the wind applies maximum load to the rotor blade. The safe-limited-speed-control function continuously monitors the speed of the actuation of the component during all modes actuating the component. E.g. in case of rotor blades of a wind turbine as the actuated component the maximum speed to be acceptable is 6°/sec for rotating the blade about its longitudinal axis. The safe-direction-control function monitors the moving direction of the component, e.g. direction forth or back in case of linear movements or right of left in case of rotations. The safe-torque-off-control function removes power from the electromechanical motor by blocking the corresponding motor control signal in order to provide zero torque to the component and can be used by other safety function as part of these other safety functions. The safe-brake-control function for instance removes power from the brake in order to engage the brake implying a brake type required to be de-energized to cause the brake to engage and can be used by other safety function as part of these other safety functions. The safe-stop-control function may initiate a deceleration of the electromechanical motor and subsequently, after a specific time delay, commanding application of the safe-torque-off-control function and the safe-brake-control function to achieve a safe state of the component and can be used by other safety function as part of these other safety functions.

Furthermore at least the safety functions safe-limited-position-control function, safe-limited-speed-control function and safe-direction-control function may comprise defined fault reactions in order to guarantee reliability, integrity and diagnostics of the actuation of the component. The fault reaction of the safe-limited-position-control function, safe-limited-speed-control function and/or the safe-direction-control function might demand execution of the first safety function or demanding the safe-stop-control function depending on the operation mode of the drive system.

In order to execute safety functions such as first safety function, safe-limited-position-control function, safe-limited-speed-control function and/or safe-stop-control function, safety related commands and data might be sent via the third data connection, e.g. a full duplex data bus, to the conventional motor control unit.

In one aspect of the invention the electromechanical drive system comprises a measuring unit with a resolver for determining motor position and/or motor speed data for driving the motor in a first mode by using the motor position and/or motor speed data of the resolver. The safety module is adapted to perform a plausibility check between the data delivered by the measuring unit and the sensor data delivered by the position sensor. In case the plausibility check indicates a malfunction of the position sensor the component is actuated by the safety module into the resting or neutral position by using the data provided by the measuring unit.

In case of a wind turbine for example, the data of the measuring unit is used instead of the data of the position sensor that cannot be longer trusted, for monitoring and estimating, respectively the blade position. With the estimated blade position correct speed commands can be issued to the motor control unit to continue operating the motor until the rotor blades have reached the feathering position and to stop the motor in this position. Although the data from the measuring unit does not allow to check if the gearbox between the motor and the rotor blade is working properly, this is considered secondary in view of the risk to leave the rotor blade fully exposed to the wind.

In another aspect of the invention the electromechanical drive comprises a measuring unit with a resolver for determining motor position and/or motor speed. The safety module is adapted to perform a plausibility check between the data delivered by the measuring unit and the sensor data delivered by the position sensor 5. In case the plausibility check indicates a malfunction of the resolver the safety module actuates the component into the resting or neutral position by switching the motor into a second mode wherein the measuring unit drives the motor without using the input of the resolver.

In one embodiment the conventional motor comprises a conventional measuring unit which is suitable to determine motor position and/or motor speed data. As an example, the measuring unit is a resolver determining motor position and motor angle. The data from the measuring unit are transmitted to the conventional motor control unit as motor signals. With the high resolution of available resolvers the motor can be controlled precisely in a first mode, which is called herein “normal mode”. As another embodiment the conventional measuring unit determines motor position and/or speed in a second mode, which is herein called “sensorless mode”, as the position of the motor shaft is estimated without having a sensor, such as the resolver or an encoder that physically measures angles. Instead, an angle-dependant trait in the motors physical construction, which could be either inherent, or deliberately added, is used to estimate the shaft angle by a selfsensing realtime algorithm, e.g. a Kalman Filter, which uses the actual motor current as an input to determine the position and/or speed of the motor. The results are not as precise, but sufficient for the purpose of continuing an emergency operation until the resting position or the neutral position has been reached.

In another aspect of the invention the electromechanical device comprises a measuring unit with a resolver for determining motor position and/or motor speed. The safety module is adapted to perform a plausibility check between the data delivered by the measuring unit and the sensor data delivered by the position sensor. In case the plausibility check indicates that neither the data from the measuring unit nor the data of the position sensor are trustworthy, the safety module stops the motor.

Additionally, in case of a system of electromechanical devices the safety module informs other safety modules in the system about faults/failures. Optionally the other safety modules on receipt of the notification of this failure may actuate their components into the resting or neutral position. In case of a wind turbine with three rotor blades, in case of failure of one blade the other two blades, if they manage to reach the feathering position will be able to bring the rotor to a stop.

In an embodiment the safety module comprises a PWM blocker module receiving the motor control signals from the conventional motor control unit, where execution of at least one of the safe-torque-off-control function and/or safe-stop-control function results in blocking the motor control signal from passing the PWM blocker module towards the conventional power control unit. The PWM motor control signal inputted from the conventional motor control unit to the PWM blocker module controls the electromechanical motors standard behavior, where power is switched to the motor based on PWM motor signal demands. The PWM blocker module is adapted to override the motor control signal coming from the conventional motor control unit in order to execute this safety function. In a preferred embodiment the output of the PWM blocker module is set to 0V in order to execute this safety function. Setting the safety input for the PWM blocker module to 0V results in setting the output of the PWM blocker module to the conventional power unit to 0V. This embodiment enables to implement the safety function of stopping the motor easily into the motor control signals without requiring a safe motor control unit.

In an embodiment the safety module further comprises a brake blocker module receiving a brake control signal as another type of motor control signal from the conventional motor control unit, where execution of at least one of the safe-brake-control function and/or safe-stop-control function results in blocking the brake control signal from passing the brake blocker module towards the conventional power control unit. The brake control signal inputted from the conventional motor control unit to the brake blocker module controls the electromechanical motors standard behavior including brake action, where power is switched to the brake based on brake signal demands (possibly also PWM signals). The brake blocker module is adapted to override the brake control signal as motor control signal coming from the conventional motor control unit in order to execute this safety function. In a preferred embodiment the output of the brake blocker is set to 0V to execute this safety function. Setting the safety input for the brake blocker module to 0V results in setting the output of the brake blocker module to the conventional power unit to 0V. This embodiment enables to implement the safety function easily into the motor control signals without requiring a safe motor control unit. The motor control signals comprise a motor control signal in order to drive the motor and the brake control signal in order to brake the motor.

For executing the safe-stop-function, the above described procedures also apply for executing the safe-torque-off-control function and safe-brake-control function as part of the safe-stop-function. Furthermore the first safety function as well as safe-limited-position-control function, safe-limited-speed-control function and safe-direction-control function comprise execution of safe-torque-off-control function and safe-brake-control function when finishing an actuation in accordance to these safety functions.

In another aspect of the invention in case of detected errors in communication and/or operation of the motor control unit, the safety module is adapted to reset the motor control unit via a direct access to a reset line of the motor control unit. In case the plausibility check fails one strategy is to reset the motor control unit. As this reset typically takes less than a second it is worth while trying a reset, especially when for example the actual wind conditions indicate no instant risk. The reset may enable the electromechanical motor to actuate component into a a resting or neutral position. In a system of electromechanical motors it may be a good strategy to lower the risk of a total system failure to send after a reset a first safety function to all electromechanical motors of the system to urge them in a safe position, i.e. a resting or neutral position.

In another aspect of the invention the safety module of the electromechanical drive system is adapted in case of actuating the component into the resting or neutral position to modify the speed commands for the motor such that in a first part the speed of the motor is increased and that in a second part the speed of the motor is decreased.

The modification of commands that include increasing the speed of a motor bears a great risk and usually would be avoided, As long as results delivered by the safety position sensor are trustworthy this risk is mitigated against the advantage of increasing the speed by which the actuated component can be from a risky position into a position where the risk of damages is considerably lowered. In case of a wind turbine, turning the blades out of the wind by 30° lowers the lift produced by a rotor blade significantly. Thus the quicker the blades are turned out of the wind the faster the wind turbine is in a safe state. As the blades then can be even turned slower, the final position can be achieved more accurately.

In an embodiment the safety module is adapted to prove an error-free communication and operation of the conventional motor control unit by a so-called heartbeat-signal, where the conventional motor control unit answers the heartbeat signal in a predetermined manner in case of operating properly. The execution of heartbeat signal comprises a procedure, where a counter of the safety module is incremented and a value is written to a first parameter in the next heartbeat signal to be sent to the conventional motor control unit. In parallel the safety module starts a timer to check for communication timeout with the conventional motor control unit.

The heartbeat signal is fired periodically to the conventional motor control unit, e.g. via the third data connection, where the heartbeat signal initiates a new message exchange with the safety card. The conventional motor control unit copies and optionally bit-wise inverts the value of the specific parameter to a second specific parameter according to a mapping configuration including this second specific parameter into the message sent back to the safety module, e.g. via the third data connection. The safety module reads the value of the second parameter from the received back message and confirms the value (optionally bit-wise inverted) is equal to its own counter. If the timer within the safety module expires before reading the message from the conventional motor control unit or the compared value differs from the own counter, a fault reaction scheme is initiated. The fault reaction might be the execution of the first safety function. The correctly working communication between safety module and the conventional motor control unit ensures control commands transmitted from the safety module can be executed by the conventional motor control unit, which as a diagnostic procedure increases the degree of reliability and integrity of the electromechanical drive system. In a preferred embodiment, in case of detected errors in communication and/or operation of the conventional motor control unit, the safety module is adapted to reset the conventional motor control unit via a direct access to a reset line of the conventional motor control unit as the first executed fault reaction before initiating other fault reactions. This measure resulting from the previous diagnostic procedure enables the safety module to get the motor control unit working properly again in order to further improve the degree of reliability and integrity of the electromechanical drive system. The re-establishment of a working system provides an improved solution to enable continuing the normal operation of the component compared to the mere execution of an emergency actuation of the component.

In an embodiment the safety module is arranged as a plug-in safety card comprising a first interface as the third data connection to connect the safety card to the conventional motor control unit in order to at least transmit the actuation signals to the conventional motor control unit and second interfaces to transmit motor control signals and/or brake control signal as another type of motor control signals to the conventional power unit via the safety card. These embodiments provide the possibility to develop the safety related circuits separately to the wiring of the conventional components in a plug-in solution applicable to different applications in order to save development, manufacturing and component costs. In a preferred embodiment the first interface comprises a FS-bus as safety interface and/or a SSI interface as a conventional data interface to execute this data transfer. Here the first interface might be a conventional SSI interface with safety measures like check sum algorithms implemented on it or might be a safe interface or arranged as a combination of safe and conventional interfaces. Via this data connection the conventional motor control unit may transmit non-safe speed and position data of the motor as well as motor temperature feedback and status data to the safety module in order to provide feedback to the execution of the actuation signals. Here, the safety card denotes a printed circuit board comprising the required hardware and software components in order to execute the implemented safety functions. The safety card and the motor control unit might be arranged within the same housing. In an alternative embodiment the safety card and at least the conventional motor control unit are arranged on the same printed circuit board. In a preferred embodiment the first interface is a FS-bus denoting any data communication protocol compliant with IEC 61784-3 or its corresponding additional specification IEC 61784-3-x, preferably a FSOE (EtherCat) or a ProfiSafe (ProfiNet) bus denoting interfaces with implemented safety protocols according to IEC 61508 Standard.

In a further embodiment the electromechanical drive system comprises at least two electromechanical drive units, where the safety modules of the electromechanical drive units are connected to each other in order to at least exchange information comprising information about any applied safety function in order to trigger the other safety modules to execute corresponding safety functions in an aligned way. The number of electromechanical drive units depends on the particular application. In more complex applications, the actuation of different components especially when interacting in a certain way, e.g. multiple rotor blades of a wind turbine or ship propeller each accelerated (in case of wind) or loaded (in case of a ship propeller) separately but mechanically connected as a propeller to the same rotation axis, requires alignment of the separate actuations in order to provide an overall efficient and safe system. This alignment is possible for electromechanical drive units connected to each other in order to exchange information.

In an preferred embodiment the connection is established via a central unit comprising a central unit safety card connected to each electromechanical drive unit via a suitable bidirectional interface to send demanded actuation and/or position data for the components to the safety modules of each electromechanical drive unit for generating corresponding actuation signals and also sending at least a first safety signal to the safety modules in an emergency situation, where the safety modules are adapted to execute the first safety function in response to the first safety signal. The central unit safety card denotes an arrangement of components, where one or more safety functions are implemented. The central unit safety card may comprises one or more processors or computer chips able to execute one or more programmed procedure and/or to control semiconductor components installed on the central unit safety card in order to execute the programmed procedures. The central unit safety card might be connected directly or indirectly via interfaces within the safety modules in order to execute the programmed procedures. In a preferred embodiment the bidirectional interface is a FSOE (EtherCat) interface. Under normal operation the central unit, preferably the central unit safety card, may issue speed commands for the conventional motor control units via the safety modules of each electromechanical drive unit in order to execute component actuations in an aligned manner. The possibility to send safety commands such as a first safety signal to the electromechanical drive units provides additional safety related functionality to the system according to the present invention on a central level, which can consider the overall situation of the system, which might be in an emergency situation when considered together, which might be not the case, when only considering the same situation of the system purely on a drive unit level. The safety modules of each electromechanical drive unit will at least execute the first safety function in response to the first safety signal received from the central unit being supervising in this case.

The separate safety modules might be arranged in an embodiment to also execute the first safety function in case of lost communication connection to the central unit or in case of an internal error within the central unit. Here the safety module is a man-in-the-middle device between conventional motor control unit and central unit. In another embodiment the central unit may comprise a central unit safety card executing at least some of the safety related functions (e.g. the first safety function) and a central unit control card sending the demanded actuation and/or position data to the components. The central unit safety card is a component in addition to the safety modules in electromechanical drives units and acts as a co-ordinator to ensure that if one electromechanical drive unit executes the first safety function the central unit safety card demands all others safety modules of the other electromechanical drive units to react also with execution of the first safety function. The central unit safety card also acts to spread the demand of executing a first safety function from the central unit to all electromechanical drive units.

In another embodiment each safety module is adapted to report at least safe position and/or speed data of the component from the safety module to the central unit, where the central unit safety card is adapted to compare the reported safe position and/or speed data to a demanded position and/or speed of each actuator and in case of a mismatch is adapted to send the first safety signal to each safety module. This enables the central unit to execute plausibility checks between the demanded positions of the components actuated by the electromechanical drive units and the current position measured by the safety position sensor and reported to the central unit via the corresponding safety modules. In case of a central unit comprising a central unit control card in addition to the central unit safety card, the plausibility checks are performed on the central unit safety card. Safe position or speed data denote the position or speed data received from the safety position sensor.

The invention further relates to a pitch system suitable to rotate at least one rotor blade, preferably all rotor blades, of a wind turbine comprising an electromechanical drive system according to the present invention for rotating the rotor blades, where the rotor blade is the component to be actuated, where the electromechanical motor is adapted to rotate the rotor blade about its longitudinal axis as the actuation and where a safe feathering run to rotate the rotor blade in a feathering position is the first safety function. The term “pitch system” denotes any system suitable to rotate the rotor blades of a wind turbine about its longitudinal axis. The pitch system for wind turbines has to fulfil two essential functions: First, it performs as an actuator for the turbine speed and power control when the wind speed exceeds the turbine's rated values and second, it acts as an actuating system for braking the wind turbine. The term “safe feathering run” denotes a stopping procedure for the wind turbine, where all or at least a sufficient number of rotor blades have to be moved into the feathering position, where the wind does not apply an accelerating force to the particular rotor blades and the loads on all structural parts during the procedure are distributed and balanced. In order to reach the feathering position, the rotor blades are moved out of the wind synchronously. The feathering run is the only possibility to stop a wind turbine, because the force on the rotor blades applied by the wind exceeds the braking forces of any applicable electromechanical brake systems.

In an embodiment the electromechanical drive system comprises two or more electromechanical drive units, further comprising a central unit connected to each electromechanical drive unit for each rotor blade via an suitable bidirectional interface, preferably a FS-bus or a FSOE interface, to send demanded rotation and/or position data for the rotor blades to the safety modules of each electromechanical drive unit for generating rotation signals and also sending a feathering signal to the safety modules in case of an emergency situation, where the safety modules are adapted to execute the safe feathering run for each rotor blade in response to the feathering signal. In a preferred embodiment the central unit is adapted to execute the safe feathering run for at least two out of three rotor blades in case of a wind turbine comprising three rotor blades or for at least one out of two rotor blades in case of a wind turbine comprising two rotor blades in order to transfer the loaded rotor into the feathering position (or state). This means, that a failure of one electromechanical drive unit being not able to execute the safe feathering run for its particular rotor blade can be safely managed via the central unit and the other rotor blades executing a safe feathering run being adapted for the participating rotor blades compensating the effect of the one rotor blade unable to execute its safe feathering run resulting in safe stopping the rotor. In an embodiment in case of an execution of a fault reaction by an electromechanical drive unit the fault is reported to the central unit by the corresponding safety module of the electromechanical drive unit. The faults reported may comprise the fault of not being able to execute a safe feathering run.

The invention further relates to a wind turbine comprising two or more rotor blades, where each rotor blade is rotated by a separate electromechanical motor of the pitch system according to the present invention.

In an embodiment the wind turbine further comprises a turbine control unit arranged in a nacelle of the wind turbine adapted to transmit position and/or speed commands for rotating each rotor blades to the central unit, where the central unit safety card is adapted to compare the transmitted position and/or speed commands as demanded position of each rotor blade to safe position and/or speed data reported to the central unit by each safety module and in case of a mismatch to send the feathering run signal to each safety module in order to execute the safe feathering run. A wind turbine comprises a tower comprising a nacelle on top of the tower being able to rotate about the vertical axis of the tower. The nacelle further comprises a horizontal rotation axis, where the rotor comprises a hub, which rotates about the horizontal rotation axis and being accelerated or decelerated by rotor blades mounted to the hub essentially vertical to the horizontal rotor axis. The turbine control unit provides overall control of the turbine and being connected to the grid. The connection to the central unit might be established via a FS bus or a FLD bus, where the FLD bus denotes any real-time industrial Ethernet or industrial fieldbus based data communication protocol such as ProfiBus or CAN, via a slip ring connection to the pitch system arranged in the rotor as the rotating part of the wind turbine. When used with an FS-bus, the FLD-bus is capable of supporting that FS-bus, e.g. EtherCat with FSOE or ProfiNet (ProfiBus) with ProfiSafe. In an embodiment, the communication between turbine central unit and the central unit of the pitch system may be established via an FLD-bus with FS-bus for safe communication of position and/or speed commands as well as demanded execution of the first safety function to the central unit. In another embodiment, the communication between turbine central unit and the central unit of the pitch system may be established via a non-safe FLD-bus for communication of position and/or speed commands and via a safety chain input connection established as a means for demanding execution of the first safety function to the central unit. The safety chain input to demand the first safety run might be a value set to 0V.

In another embodiment the central unit is adapted to compare the differences between the current angle/position of the rotor blades and in case of detecting a deviation between the present angle position of two or more rotor blades (relative to the wind), the central unit issues the feathering signal as the first safety signal to signal (command) execution of a safe feathering run in case of the differences exceeding a certain predetermined limit.

The invention further relates to a method to operate an electromechanical drive system according to the present invention with least one electromechanical drive unit comprising an electromechanical motor to actuate a movable component, where reliability, integrity and diagnostics of the actuation of the component is safety-relevant for operating the component, a conventional power unit to power the electromechanical motor, a conventional motor control unit connected to the conventional power unit in order to control the conventional power unit via motor control signals, a conventional measuring unit connected to the conventional motor control unit to determine motor position and/or motor speed data and to send these data as motor signals (MS) to the conventional motor control unit, a safety module connected to conventional motor control unit and conventional power unit, and an safety position sensor connected to the safety module, comprising the steps of
monitoring component position and/or speed of the actuated component with a sufficient degree of reliability and integrity to fulfill safety requirements for the safety-relevant actuations by the safety position sensor, preferably a position encoder;
sending corresponding sensor signals comprising position and/or speed data to the safety module via a first data connection by the safety position sensor;
transmitting actuation signals like actuation speed and desired component position from the safety module to the conventional motor control unit via a third data connection;
transmitting the motor control signals via the safety module to the conventional power unit in order to enable execution of safety functions by the safety module;
actuating the component by the electromechanical motor based on the motor control signals resulting from the actuation signals in accordance to one or more safety functions at least implemented on the safety module to ensure safe actuation of the component;
comparing the monitored position and speed of the component with an expected behavior from the actuation signals by the safety module;
actuating of the component in a resting or neutral position as a first safety function executed by safety module at least in an emergency situation.

### BRIEF DESCRIPTION OF THE DRAWINGS

The aforementioned and other aspects of the invention will also be apparent from and elucidated with reference to the embodiments of the invention described herein after making reference to the drawings.

FIG. 1: shows an embodiment of the electromechanical drive system according to the present invention;

FIG. 2: shows another embodiment of the electromechanical drive system (or pitch system) according to the present invention comprising a central unit;

FIG. 3: shows another embodiment of the electromechanical drive system related to fault reaction;

FIG. 4: shows an embodiment of the wind turbine according to the present invention;

FIG. 5: shows a method to operate the electromechanical drive system according to the present invention.

### DETAILED DESCRIPTION OF EMBODIMENTS

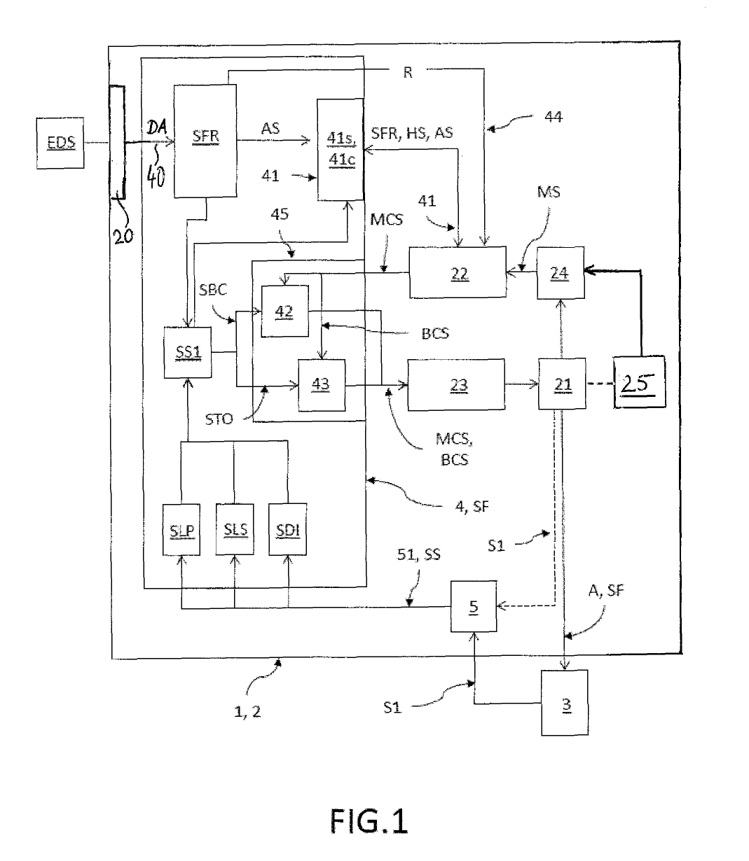

FIG. 1 shows an embodiment of the electromechanical drive system 1 according to the present invention established by one electromechanical drive unit 2 actuating the movable safety-relevant component 3 comprising a drive unit interface 20 for receiving drive unit control signals DA, an electromechanical motor 21, where a conventional power unit 23 powers the electromechanical motor 21, a conventional motor control unit 22 is connected to the conventional power unit 23 and controls the conventional power unit 23 via motor control signals MCS and a conventional measuring unit 24, which is connected to the conventional motor control unit 22 to determine motor position and/or motor speed data and to send these data as motor signals MS to the conventional motor control unit 22. For this purpose the measuring unit 24 comprises a resolver 25 that is attached to the motor shaft for determining motor position and motor angle. In this embodiment the chosen resolver 25 provides a high resolution of 16 bit for one complete turn of the motor shaft. Thus the electrical motor 21 can be controlled precisely in a first mode, which is called herein “normal mode”. Alternatively the conventional measuring unit 24 is configured to determine motor position and/or speed in a second mode, which is herein called “sensorless mode”. In sensorless mode the position of the motor shaft is estimated without using the resolver 25. Instead, an angle-dependant trait in the motors physical construction, which could be either inherent, or deliberately added, is used to estimate the shaft angle by a selfsensing realtime algorithm, e.g. a Kalman Filter, which uses the actual motor current as an input to determine the position and/or speed of the motor. The results are not as precise as with the use of a high resolution resolver 25, but sufficient to operate the motor. The mode of operation can be demanded by the safety module 4.

The reliability, integrity and diagnostics to provide safe actuation A of the component 3 is achieved by a safety module 4, arranged as a plug-in safety card in this embodiment, and an safety position sensor 5, where the safety position sensor 5 monitors S1 component position and/or speed of the actuated component 3 with a sufficient degree of reliability, integrity and diagnostics to fulfill safety requirements for the safety-relevant actuations and is connected to the safety module 4 via a first data connection 51 sending corresponding sensor signals SS comprising position and/or speed data to the safety module 4. The safety position sensor 5 might be a safe linear or rotary encoder providing safe absolute position, speed and fault status data via a FS-bus interface 51 developed according to the IEC 61508 Standard as the first data connection 51 to the safety module 4. In case of a rotary encoder for rotations as the actuations the safety position sensor 5 might be a SIL rated multi-turn encoder. In an alternative embodiment the sensor signals SS transmitted from the safety position sensor 5 may be based on measured motor position and/or speed of the motor 21 as long as the data measured from the motor 21 provide a sufficient degree of reliability and integrity to fulfill safety requirements. The measurement of the motor position and/or speed data is indicated by the dashed arrow S1 directing from the motor 21 to the safety position sensor 5. The safety position sensor 5 might be attached to a motor shaft (not shown in detail here), where a direct correlation between shaft position and speed and component position and speed exists. The safety position sensor 5 may be alternatively attached to the output of a gearbox (not shown), where an indirect correlation between motor shaft coupled to the input of the gear box and the output shaft of the gearbox exists. A gearbox pinion may drive a crown wheel or annular gear (not shown) for rotating the blade of a wind turbine. The attachment of the position sensor 5 to the output of a gearbox, the pinion of a gearbox, a crown wheel or annular gear has the advantage that the safety position sensor 5 allows to supervise the proper function of the gearbox or the rotation of the rotor blade. However, the correlation of motor speed and rotation speed of the rotor blade could be blurred by play/backlash of the gears in the gearbox and other components of the transmission.

The sensor signals SS are further processed by the safety module 4 in order to calculate component position and/or speed from the motor position and/or speed. Via a second data connection 40 the safety module 4 is connected to the data drive unit interface 20. The safety module 4 is further connected to the conventional motor control unit 22 via a third data connection 41 to transmit actuation signals AS like actuation speed and desired component position to the conventional motor control unit 22 for actuating A the component 3 in accordance to one or more safety functions SF at least implemented on the safety module 4 to ensure safe actuation of the component 3, where the third data connection 41 comprises a first interface 41, preferably comprising a FS-bus as safety interface 41s and/or an SSI interface as a conventional data interface 41c. In order to ensure that the conventional motor control unit 22 indeed receives the actuation signals AS, the safety module 4 is adapted to prove an error-free communication and operation of the conventional motor control unit 22 by a so-called heartbeat-signal HS, where the conventional motor control unit 22 answers the heartbeat signal HS in a predetermined manner in case of operating properly. In case of detected errors in communication to and/or operation of the conventional motor control unit 22, the safety module 4 resets R the conventional motor control unit 22 via a direct access 44 to a reset line of the conventional motor control unit 22. A performed reset R may cause instant execution of the first safety function SFR. Alternatively, the safety module 4 may be configured to cause the first safety function SFR only if the reset fails or after a predetermined number of failed resets.

The safety module 4 compares the monitored position and/or speed of the component 3 with an expected behavior from the actuation signals AS and controls the motor control signals MCS transmitted to the conventional power unit 23 via the safety module 4. Therefore the safety module 4 comprises a PWM blocker module 42 receiving the motor control signals MCS from the conventional motor control unit 22, where execution of at least one of the safe-torque-off-control function STO and/or safe-stop-control function SS1 results in blocking the motor control signal MCS from passing the PWM blocker module 42 towards the conventional power control unit 23, preferably the output of the PWM blocker module 42 is set to 0V. The safety module 4 further comprises a brake blocker module 43 receiving a brake control signal BCS as another type of the motor control signal MCS from the conventional motor control unit 22, where execution of at least one of the safe-brake-control function SBC and/or safe-stop-control function SS1 results in blocking the brake control signal BCS from passing the brake blocker module 43 towards the conventional power control unit 23, preferably the output of the brake blocker module 43 is set to 0V.

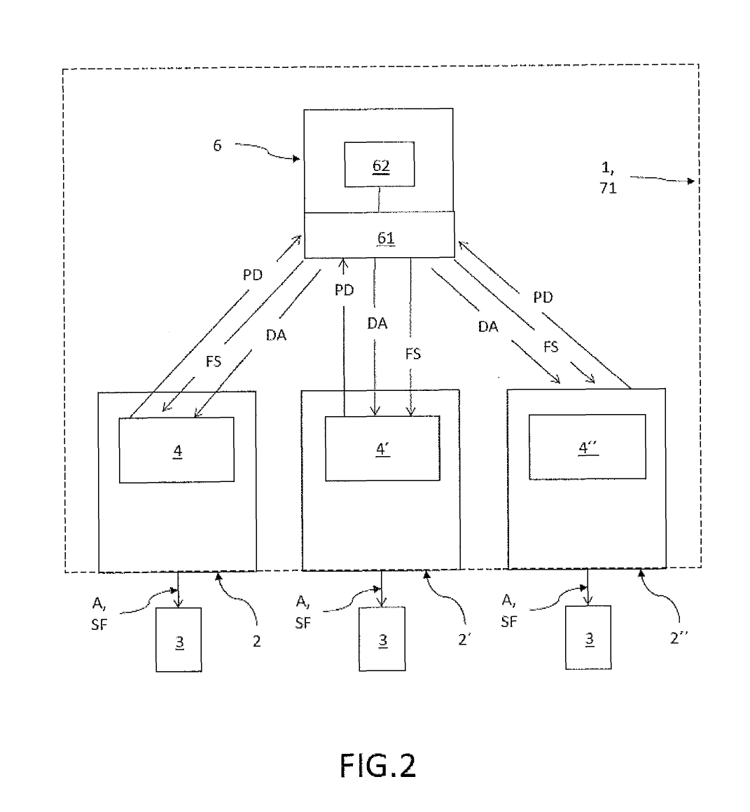

The safety functions SF comprise the actuation A of the component 3 in a resting or neutral position FP as a first safety function SFR executed by safety module 4 at least in an emergency situation and a safe-limited-position-control function SLP to ensure the position of the component 3 being within a certain range of allowed positions, a safe-limited-speed-control function SLS to ensure the speed of the actuated component 3 not exceeding a maximum speed, a safe-direction-control SDI function to ensure the component 3 being actuated into the desired direction, a safe-torque-off-control STO function to ensure that the torque applied to the component 3 is zero, a safe-brake-control function SBC to ensure the brake is applied and a safe-stop-control function SS1 to ensure execution of a stopping procedure in accordance to other safety functions SF. Therefore in this embodiment the safe-stop-control function SS1 is also connected to the first interface 41 in order to advise the conventional motor control unit 22 via the first interface 41 to decelerate the motor 21, e.g. as a part of the first safety function SFR. In this embodiment the safety module 4 acts as a man-in-the-middle device between the conventional motor control unit 22 and an external data source EDS providing demanded input data to execute a component actuation to a certain position in a certain way in accordance to one or more safety functions SF, where in response actuation signals AS like actuation speed and desired component position are transmitted from the safety module 4 to the conventional motor control unit 22. As an example the data source might be a central unit 6 as shown in FIG. 2. The safety module 4 is adapted to execute these implemented safety functions FS, therefore comprising one or more processors or computer chips able to execute a programmed procedure and/or to control semiconductor components installed on the safety module 4 in order to execute the programmed procedures. The required components of the safety module 4 are connected directly or indirectly via interfaces of the safety module 4 to the other components of the electromechanical drive unit 2 in order to execute the programmed procedures. These details are not shown explicitly in FIG. 1.

The safety module 4 is adapted to perform plausibility checks of the data delivered by the measuring unit 24 and the sensor data delivered by the safety position sensor 5. In case the plausibility check indicates that neither the data from the measuring unit nor the data of the position sensor are trustworthy, for example that the reported speed of the measuring unit is significantly lower or higher than the speed detected by the safety position sensor 5, taking into account a margin for the imperfect correlation of the speed directly measured at the motor shaft and indirectly calculated from the safety position sensor at the output of the gearbox, the safety module 4 has to decide which of the two sensors, either the resolver 25 or the safety position sensor 5 it trusts more.

In case the chosen safety position sensor 5 is one that provides an error signal that is emitted when the permanent self-test of the safety position sensor 5 detects a mal function then in case no such error code is received by the safety module 4, the safety module would give preference to the speed information derived from the safety position sensor 5 over the speed information derived from the resolver 26. The person skilled in the art will appreciate that additional plausibility test may be applied, such as taking into account the amount of speed reported. If the derived speed from the safety position sensor 5 is much higher than a speed that is technically possible, then the safety module 4 may decide to trust the speed information provided from the resolver 25 or to not trust both speed informations.

In case the plausibility check indicates a malfunction of the safety position sensor 5 the safety module will initiate the first SFR, which causes the rotor blade to be actuated by the electrical motor 21 into the feathering position by using the position data/speed data provided by the resolver 25. In this case the safety module 4 uses the data provided by the measuring unit 24 instead of the data provided by the position sensor that cannot be longer trusted, for monitoring and estimating, respectively the rotor blade position. With the estimated rotor blade position correct speed commands can be issued to the motor control unit 21 to continue operating the electrical motor 21 until the rotor blades have reached the feathering position and to stop the motor in this position. Although the data from the measuring unit does not allow to check if the gearbox between the motor and the rotor blade is working properly, this is considered as a lower risk than to leave the rotor blade fully exposed to the wind.

In the event that the plausibility check indicates a malfunction of the resolver 25 the safety module actuates the component into the feathering position by switching the motor from normal operation mode into sensorless operation mode wherein the measuring unit drives the motor without using the input of the resolver 25. In case the plausibility check indicates that neither the data from the measuring unit nor the data of the position sensor are trustworthy, the safety module stops the motor immediately. In order to ensure that stopping the motor is inhibited by a malfunction the safety module 4 in addition to modifying the speed indicated to the motor unit 21 to zero the safety module 4 may also invoke the PWM blocker to ensure that the electrical motor 21 is stopped reliably.

As explained before, the safety module 4 may modify the speed commands received as demanded actuation commands DA received at the drive unit interface 20, before it forwards the commands as actuation signal AS to the conventional motor control unit 22. In case of executing the first safety function, e.g. actuating the rotor blades into a feathering position, the safety module 4 will modify the command so that in a first part the speed of the electromechanical motor 21 is increased, in second part the demanded speed is uphold and in a third part, when the rotor blade approaches the final position, the speed of the motor is decreased. Specific information of the duration, the actual speed increase and decrease depend on the dimension of the wind turbine and the electromechanical characteristics of the electromechanical motor 21, to name two of the various factors. The person skilled in the art will also appreciate that these modifications may be applied in only two steps, or in even more than three steps.

FIG. 2 shows another embodiment of the electromechanical drive system 1 (or pitch system 71) according to the present invention comprising a central unit 6 comprising a central unit safety card 62, where one or more safety functions SF are implemented. The details of the electromechanical drive unit 2, 2″ and 2″ are shown in FIG. 1. The electromechanical drive system 1 (or pitch system 71) of FIG. 2 comprises three electromechanical drive units 2, 2″, 2″, where the safety modules 4, 4″, 4″ of the electromechanical drive units 2, 2″, 2″ are connected to the central unit safety card 62 of the central unit 6 via a suitable bidirectional interface 61, preferably a FSOE interface, to send demanded actuation and/or position data DA for the components to the safety modules 4, 4″, 4″ of each electromechanical drive unit 2, 2″, 2″ for generating corresponding actuation signals AS. Also a first safety signal FS might be sent to the safety modules 4, 4″, 4″ in an emergency situation. The safety modules 4, 4″, 4″ will execute the first safety function SFR in response to the received first safety signal FS. The central unit 6 enables the execution of safety functions SF for all electromechanical drive units 2, 2″, 2″ in an aligned way. Furthermore each safety module 4, 4″, 4″ reports at least the safe position and/or speed data PD of the component 3 to the central unit safety card 62, which compares the reported position and/or speed data PD to a demanded position and/or speed of each actuator A and in case of a mismatch will send the first safety signal FS to each safety module 4, 4″, 4″.

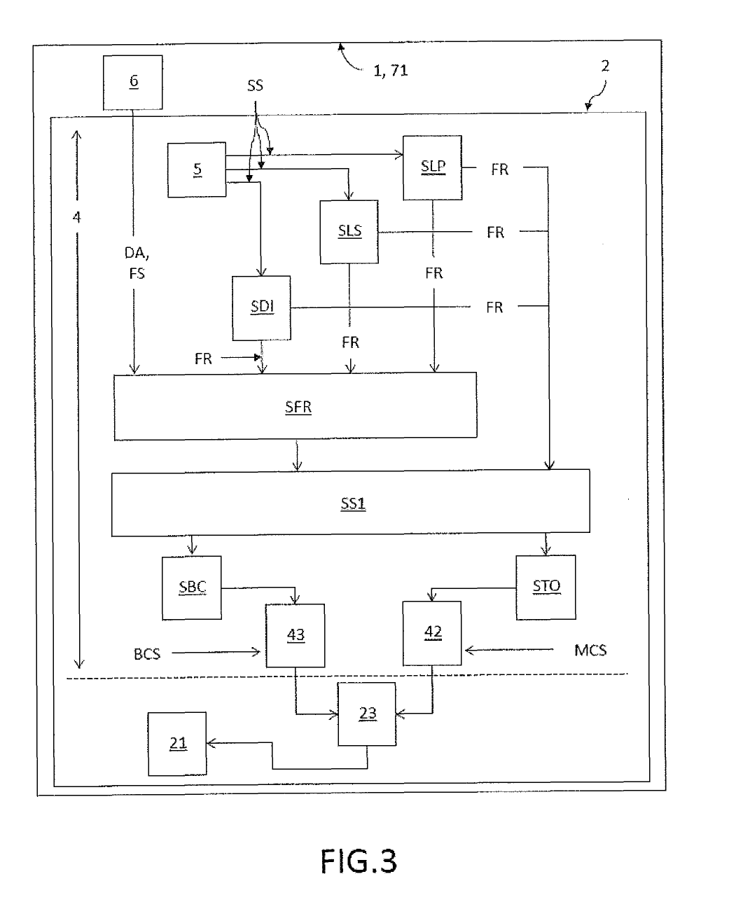

FIG. 3 shows another embodiment of the electromechanical drive system related to fault reaction for an electromechanical drive system as shown in FIGS. 1 and 2. The safety functions safe-limited-position-control function SLP, safe-limited-speed-control function SLS and safe-direction-control function SDI comprise defined fault reactions FR in order to guarantee reliability, integrity and diagnostics of the actuation A of the component 3 depending on the operation mode of the electromechanical drive system. The fault reaction FR of the safe-limited-position-control function SLP, safe-limited-speed-control function SLS and/or the safe-direction-control function SDI may demand execution of the first safety function SFR during normal operation of the electromechanical drive system or may demand the safe-stop-control function SS1 e.g. in case of manual operation of the electromechanical drive system, indicated by arrows indicated by “FR” directing either to SFR or SS1. The safety module 4 is further adapted to prove an error-free communication and operation of the conventional motor control unit 22 by a so-called heartbeat-signal HS, where a fault reaction FR scheme is initiated in response of a failed prove of a proper connection. The fault reaction FR might be the execution of the first safety function SFR. The correctly working communication between safety module 4 and the conventional motor control unit 22 ensures control commands transmitted from the safety module 4 can be executed by the conventional motor control unit 22, which as a diagnostic procedure increases the degree of reliability and integrity of the electromechanical drive system 1. In case of detected errors in communication and/or operation of the conventional motor control unit 22, the safety module 4 may reset the conventional motor control unit 22 via a direct access to a reset line of the conventional motor control unit 22. In case of an execution of a fault reaction FR by an electromechanical drive unit 2 the fault is reported to the central unit 6 by the corresponding safety module 4 of the electromechanical drive unit 2 (not shown here in details). The safe-limited-position-control function SLP monitors the component position such that the components 3 stay within a defined position range. The safe-limited-speed-control function SLS continuously monitors the speed of the actuation of the component during all modes actuating the component such that the speed stays below a maximum value. The safe-direction-control function SDI monitors the moving direction of the component, e.g. direction forth or back in case of linear movements or right of left in case of rotations. The safe-stop-control function SS1 initiates in response a deceleration of the electromechanical motor 21 and subsequently, after a specific time delay, commanding application of the safe-torque-off-control function STO and the safe-brake-control function SBC to achieve a safe state of the component. SS1, SBC and STO are also part of the first safety function SFR.

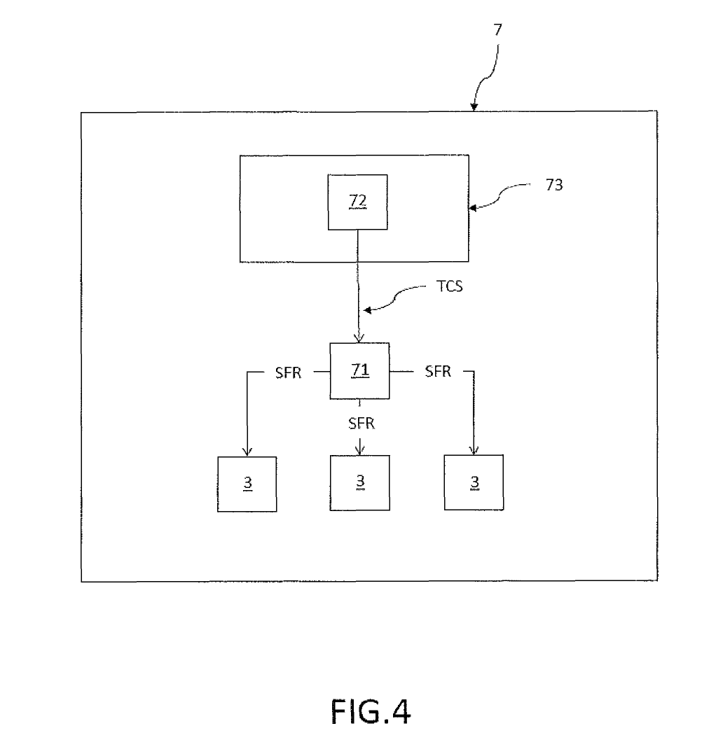

FIG. 4 shows an embodiment of a wind turbine 7 according to the present invention in a schematic view. In this embodiment the wind turbine 7 comprises three rotor blades 3 as the actuated components 3. The pitch system suitable 71 comprising the electromechanical drive system with one electromechanical drive unit 2, 2″, 2″ provided for each rotor blade 3, where the electromechanical motor 21 of each electromechanical drive unit 2 is adapted to rotate the rotor blade 3 about its longitudinal axis as the actuation A. In case of an emergency situation or as a fault reaction, a safe feathering run SFR as the first safety function rotates the rotor blade 3 in a feathering position FP. The pitch system 71 further comprises central unit 6 connected to each electromechanical drive unit 2, 2″, 2″ for each rotor blade 3 via an suitable bidirectional interface 61 to send demanded rotation and/or position data for the rotor blades 3 to the safety modules 4, 4″, 4″ of each electromechanical drive unit 2, 2″, 2″ (not shown here in details) for generating rotation signals AS and also sending a feathering signal FS to the safety modules 4, 4″, 4″ in case of an emergency situation, where the safety modules 4, 4″, 4″ are adapted to execute the safe feathering run SFR for each rotor blade 3 in response to the feathering signal FS. The wind turbine further comprising a turbine control unit 72 arranged in a nacelle 73 of the wind turbine 7 adapted to transmit position and/or speed commands TCS for rotating each rotor blades 3 to the central unit 6 (here only the pitch system 71 is shown for ease of understanding), where the central unit safety card 62 in the central unit 6 is adapted to compare the transmitted position and/or speed commands TCS as demanded position of each rotor blade 3 to position data PD reported to the central unit 6 by each safety module 4, 4″, 4″ and in case of a mismatch to send the feathering signal FS to each safety module 4, 4″, 4″ in order to execute the safe feathering run SFR. In an embodiment, the safe feathering run SFR is divided in two different parts dependent on the current position of the rotor blades 3. The first part denotes the angle region of the rotor blade 3, where positive torque is applied to the rotor blade (accelerating wind load to rotor blade). The second part denotes the angle region of the rotor blade 3, where negative torque is applied to the rotor blade (decelerating wind load to the rotor blade 3). The angle, where a transition between first and second part occurs depends on the configuration of rotor blade 3 and wind turbine 7 setup. Typically this transition angle is in the range of 30°. Since wind force induced on the wind turbine 7 is at highest in the first part it is beneficial to get the rotor blades 3 out of this blade angle region as fast as possible. For this reason, SLS might be muted during SFR until the rotor blades 3 passing the transition angle. In some embodiments the safety module 4 may modify the received drive unit control signals DA to increase the motor speed indicated in these signals before these modified signals are passed as actuation signals to the motor control unit, in order to speed up the rotation speed of the blades in the first part. After having passed the transition angle, the speed of the rotation A of rotor blades 3 around its longitudinal axis is decelerated. This may be also achieved by modifying the received drive control signals. The rotation speed further decreases when the rotor blade 3 approaches the feathering position FP. The speed might be decreased stepwise. When the rotor blades 3 have reached the feathering position FP, the safe-stop-control function is executed to finish the safe feathering run SFR. In another embodiment the central unit 6 is adapted to compare the differences between the current axis of the rotor blades 3 and in case of detecting a deviation between the present axis of two or more rotor blades 3 (relative to the wind), the central unit 6 issues the feathering signal FS to execute a safe feathering run SFR in case of the differences exceeding a certain predetermined limit.

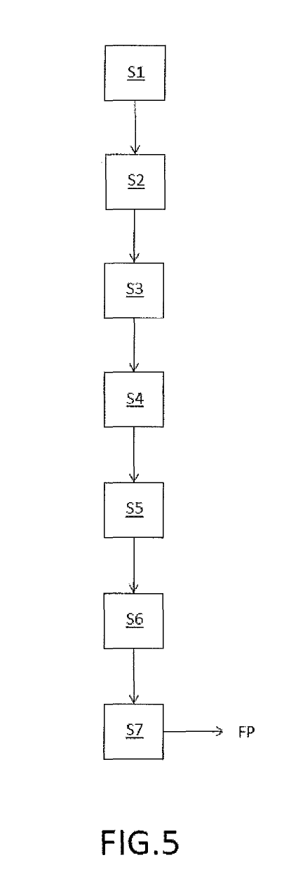

FIG. 5 shows a method to operate the electromechanical drive system according to the present invention. The method comprises the steps of monitoring S1 component position and/or speed of the actuated component 3 with a sufficient degree of reliability, integrity and diagnostics to fulfill safety requirements for the safety-relevant actuations A by the safety position sensor 5, sending S2 corresponding sensor signals SS comprising position and/or speed data to the safety module 4 via a first data connection 51 by the safety position sensor 5, transmitting S3 actuation signals AS like actuation speed and desired component position from the safety module 4 to the conventional motor control unit 22 via a third data connection 41, transmitting S4 the motor control signals MCS via the safety module 4 to the conventional power unit 23 in order to enable execution of safety functions by the safety module, actuating S5 the component 3 by the electromechanical motor 21 based on the motor control signals MCS resulting from the actuation signals AS in accordance to one or more safety functions SF at least implemented on the safety module 4 to ensure safe actuation A of the component 3, comparing S6 the monitored S1 position and speed of the component with an expected behavior from the actuation signals AS by the safety module 4, and actuating S7 of the component 3 in a resting or neutral position FP as a first safety function SFR executed by safety module 4 at least in an emergency situation.

In another embodiment, the actuated component may comprise two or more subcomponents to be actuated together or separate from each other. As an example the actuated component might by a rotor and the subcomponents might be the rotor blades. In this case the safety module relates to an electromechanical drive unit driving all subcomponents e.g. with a conventional motor control unit sending motor control signals to a motor denoting here a motor system comprising two or more sub-motors each actuating one of the subcomponents. Accordingly the safety position sensor denotes a safety position sensor system with sub-sensors measuring safe position and/or speed data related to each subcomponent.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Whilst the invention has been depicted to be advantageous for implementing a safety module and a safety position sensor in a conventional motor, it is clear that the invention may be also used for electrical motors designed from scratch as failsafe motors.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

### LIST OF REFERENCE NUMERALS

1 electromechanical drive system
2, 2″, 2″ electromechanical drive unit
20 drive unit interface
21 electromechanical motor
22 conventional motor control unit
23 conventional power unit
24 conventional measuring unit
25 resolver
3 actuated component
4, 4″, 4″ safety module
40 second data connection to drive unit interface
41 third data connection to conventional motor control unit/first interface
41s safety interface as part of the first interface
41c conventional data interface as part of the first interface
42 PWM blocker module
43 brake blocker module
44 direct access of safety module to reset line of motor control unit 22
45 second interface
5 safety position sensor, encoder
51 first data connection
6 central unit
61 bidirectional interface between central unit and electromechanical drive unit(s)
62 central unit safety card
7 wind turbine
71 pitch system
72 turbine control unit
73 nacelle
A actuation/actuating of the component
AS actuation signal
BCS brake control signal as one of the motor control signals
DA demanded actuation and/or position data send to safety module 4
EDS external data source (e.g. the central unit 6)
FP neutral or resting (feathering) position
FR fault reaction of a safety function
FS first safety signal, feathering signal
HS heartbeat signal
MCS motor control signal
MS motor signals
PD position data
R reset (command)
monitoring actuation and position of the component and/or the motor
S2 sending sensor signals to the safety module
S3 transmitting actuation signals from the safety module to the conventional motor control unit
S4 transmitting the motor control signals by the safety module
S5 actuating the component in accordance to one or more safety functions
S6 comparing monitored position/speed of the component with an expected behavior
S7 actuating the component in a resting or neutral position in an emergency situation
SF safety function
SBC safe-brake-control function
SDI safe-direction-control function
SFR first safety function/safety feathering run
SLP safe-limited-position-control function
SLS safe-limited-speed-control function
SS1 safe-stop-control function
STO safe-torque-off-control function
SS sensor signals
TCS turbine control signal

1. An electromechanical drive system comprising:
at least one electromechanical drive unit operable to actuate a movable component, the electromechanical drive unit comprising a drive unit interface for receiving drive unit control signals, an electromechanical motor controlled by actuation signals to actuate the movable component, a measuring unit comprising a resolver for determining the electromechanical motor position and/or speed, a safety module and a safety position sensor connected to the safety module via a first data connection, the safety position sensor being adapted to monitor the movable component and/or the electromechanical motor position and/or the speed of the movable component and/or the electromechanical motor;
where the safety module is connected to the drive unit interface for receiving the drive unit control signal via a second data connection, and where the safety module is connected to a motor control unit via a third data connection to transmit actuation signals like actuation speed and desired component position to the motor control unit for actuating the movable component, wherein the safety module comprises as a safety function at least the actuation of the movable component in a resting or neutral position in which the movable component will not be damaged and the environment around the movable component will not be endangered by the movable component or by malfunctions of the movable component, wherein the safety module is adapted to perform a plausibility check between data delivered by the measuring unit and the sensor data delivered by the safety position sensor; and in case the plausibility check indicates that neither the data from the measuring unit nor the data of the safety position sensor are trustworthy, the safety module stops the electromechanical motor, and in case the plausibility check indicates a malfunction of the safety position sensor to actuate the movable component by using data provided by the measuring unit until it has reached the resting or neutral position.

2. The electromechanical drive system of claim 1, wherein in case the plausibility check indicates a malfunction of the safety position sensor the safety module actuates the movable component into the resting or neutral position driving the electromechanical motor in a first mode by using the electromechanical motor position and/or the electromechanical motor speed data of the resolver.

3. The electromechanical drive system of claim 1, wherein in case the plausibility check indicates a malfunction of the resolver, the safety module actuates the movable component into the resting or neutral position by switching the electromechanical motor in a second mode wherein the measuring unit drives the electromechanical motor without using the input of the resolver.

4. (canceled)

5. The electromechanical drive system of claim 1, wherein in case of detected errors in communication and/or operation of the motor control unit, the safety module is adapted to reset the motor control unit via a direct access to a reset line of the motor control unit.

6. The electromechanical drive system of claim 1, wherein the safety module is adapted in case of actuating the movable component into the resting or neutral position to modify the speed commands for the electromechanical motor such that in a first part the speed of the electromechanical motor is increased and that in a second part the speed of the electromechanical motor is decreased.

7. The electromechanical drive system of claim 1, wherein the safety functions implemented on the safety module further comprise one or more safety functions of the following functions:
a safe-limited-position-control function to ensure the position of the movable component being within an allowed position range,
a safe-limited-speed control function to ensure the speed of the movable component not exceeding a maximum speed,
a safe-direction-control function to ensure the movable component being actuated into the desired direction,
a safe-torque-off-control function to ensure that the torque applied to the movable component is zero,
a safe-brake-control function to ensure a brake of the electromechanical motor is applied, and/or
a safe-stop-control function to ensure execution of a stopping procedure in accordance to other safety functions and where the safety module is suitably adapted to execute the implemented safety functions.

8. The electromechanical drive system of claim 7, wherein the safety module comprises at least one of
a PWM blocker module 42 receiving a motor control signals (MCS) from the motor control unit, where execution of at least one of the safe-torque-off-control function and/or the safe-stop-control function results in blocking the motor control signal from passing the PWM blocker module towards the power control unit, preferably the output of the PWM blocker module is set to 0V;
a brake blocker module receiving a brake control signal as another type of motor control signal from the motor control unit, where execution of at least one of the safe-brake-control function and/or the safe-stop-control function results in blocking the brake control signal from passing the brake blocker module towards the power control unit, preferably the output of the brake blacker module is set to 0V.

9. The electromechanical drive system of claim 1, wherein the safety module is adapted to prove an error-free communication and operation of the motor control unit by a so-called heartbeat-signal, where the motor control unit answers the heartbeat signal in a predetermined manner in case of operating properly.

10. The electromechanical drive system of claim 1, wherein the safety module is arranged as a plug-in safety card comprising a first interface as the third data connection to connect the safety card to the motor control unit, preferably comprising a FS-bus as a safety interface and/or an SSI interface as a data interface in order to at least transmit the actuation signals to the motor control unit and a second interfaces to transmit the motor control signal and/or the brake control signal to the power unit via the safety card.

11. The electromechanical drive system of claim 1, wherein the safety position sensor is a safe linear or rotary encoder providing safe absolute position and/or speed and fault status data via a FS-bus interface developed according to the IEC 61508 Standard as the first data connection to the safety module, preferably in case of a rotary encoder for rotations as actuations the safety position sensor is a SIL rated multi-turn encoder.

12. The electromechanical drive system of claim 1, wherein the electromechanical drive system comprises at least two electromechanical drive units, where the safety modules of the electromechanical drive units are connected to each other in order to at least exchange information comprising information about any applied safety function in order to trigger the other safety modules to execute corresponding safety functions in an aligned way.

13. The electromechanical drive system according to claim 12, where the connection is established via a central unit comprising a central unit safety card connected to each electromechanical drive unit via a suitable bidirectional interface, preferably a FSOE interface, to send demanded actuation and/or position data for the movable components to the safety modules of each electromechanical drive unit for generating corresponding actuation signals and also sending a first safety signal to the safety modules in an emergency situation, where the safety modules are adapted to execute the first safety function in response to the first safety signal.

14. The electromechanical drive system according to claim 13, wherein each safety module is adapted to report at least safe position and/or speed data of the movable component from the corresponding safety module to the central unit, where the central unit safety card is adapted to compare the reported safe position and/or speed data to a demanded position and/or speed of each actuator and in case of a mismatch is adapted to send the first safety signal to each safety module.

15. A pitch system suitable to rotate at least one rotor blade preferably all rotor blades, of a wind turbine comprising an electromechanical drive system according to claim 1 for rotating the at least one rotor blades, where the at least one rotor blade is the component to be actuated, where the electromechanical motor is adapted to rotate the at least one rotor blade about its longitudinal axis as the actuation and where a safe feathering run to rotate the at least one rotor blade in a feathering position is the first safety function.

16. The pitch system according to claim 15, where the electromechanical drive system comprises two or more electromechanical drive units, further comprising a central unit comprising a central unit safety card connected to each electromechanical drive unit for each rotor blade via a suitable bidirectional interface, preferably a FS-bus or a FSOE interface, to send demanded rotation and/or position data for the rotor blades to the safety modules of each electromechanical drive unit for generating rotation signals and also sending a feathering signal to the safety modules in case of an emergency situation, where the safety modules are adapted to execute the safe feathering run for each rotor blade in response to the feathering signal.

17. A wind turbine comprising two or more rotor blades, where each rotor blade is rotated by a separate electromechanical motor of the pitch system according to claim 16, the wind turbine further comprising a turbine control unit arranged in a nacelle of the wind turbine adapted to transmit position and/or speed commands for rotating each rotor blades to the central unit, where the central unit safety card is adapted to compare the transmitted position and/or speed commands as demanded position of each rotor blade to safe position and/or speed data reported to the central unit by each safety module and in case of a mismatch to send the feathering signal to each safety module in order to execute the safe feathering run.

18. A method to operate an electromechanical drive system according to claim 1 with least one electromechanical drive unit, the drive unit comprising an electromechanical motor to actuate a movable component, where reliability, integrity and diagnostics of the actuation of the component is safety-relevant for operating the component, a power unit to power the electromechanical motor, a motor control unit connected to the power unit in order to control the power unit via motor control signals, a measuring unit connected to the motor control unit, the measuring unit comprising a resolver to for determining motor position and/or motor speed data and for sending these data as motor signals to the motor control unit, a safety module connected to motor control unit and power unit, and a safety position sensor connected to the safety module, comprising the steps of
receiving drive unit control signal via a second data connection from a drive unit interface;
monitoring the movable component and/or the electromechanical motor position and/or speed of the movable component and/or the electromechanical motor with a sufficient degree of reliability and integrity to fulfill safety requirements for the safety-relevant actuations by the safety position sensor, preferably a position encoder;
sending corresponding sensor signals comprising position and/or speed data to the safety module via a first data connection by the safety position sensor;
transmitting actuation signals like actuation speed and desired component position from the safety module to the motor control unit via a third data connection;
transmitting the motor control signals via the safety module to the power unit in order to enable execution of safety functions by the safety module;
actuating the movable component by the electromechanical motor based on the motor control signals resulting from the actuation signals in accordance to one or more safety functions at least implemented on the safety module to ensure safe actuation of the movable component;
as a plausibility check comparing the monitored position and speed of the movable component with an expected behavior from the actuation signals by the safety module;
in case the plausibility check indicates that neither data from the measuring unit nor the data of the safety position sensor are trustworthy stopping the actuation of the movable component;
in case the plausibility check indicates a malfunction of the safety position sensor actuating of the movable component by using data provided by the measuring unit in a resting or neutral position in which the movable component will not be damaged and the environment around the movable component will not be endangered by the movable component or by malfunctions of the movable component as a first safety function executed by safety module at least in an emergency situation.
